(19) United States
(12) Patent Application Publication
(10) Pub. No.: US 2026/0287836 A1
(43) Pub. Date: Sep. 24, 2026

(54) PHOTONIC INTEGRATED CIRCUIT CONNECTOR WITH TEMPERATURE-INDEPENDENT MECHANICAL ALIGNMENT

(71) Applicant: 3M INNOVATIVE PROPERTIES COMPANY, St. Paul, MN (US)

(72) Inventors: Michael A. Haase, St. Paul, MN (US); Nicholas A. Lee, Woodbury, MN (US)

(21) Appl. No.: 19/687,182

(22) Filed: May 26, 2026

Related U.S. Application Data
(63) Continuation of application No. 17/637,151, filed on Aug. 27, 2020, now abandoned.
(60) Provisional application No. 62/892,633, filed on Aug. 28, 2019.

(51) Int. Cl. G02B 6/42; G02B 6/38

(52) U.S. Cl. CPC G02B 6/4249; G02B 6/3897; G02B 6/423; G02B 6/4266; G02B 6/3885

(57) ABSTRACT

An optical assembly includes an optical ferrule configured to receive light from an optical waveguide and including at least four ferrule alignment features; and a cradle securing the optical ferrule therein and configured to align the optical ferrule to an optical component, the cradle including at least four cradle alignment features configured to make contact or near contact with the at least four ferrule alignment features in a one to one correspondence in at least four corresponding contact regions, such that as a temperature of at least one of the cradle and the optical ferrule changes sufficiently, the corresponding alignment features of the optical ferrule and the cradle slide relative to each other causing the corresponding alignment features of the optical ferrule and the cradle to move to define corresponding traversed regions, such that when extended, the traversed regions of the at least four ferrule alignment features and the at least four cradle alignment features pass within 20 microns of a same first point.

### SUMMARY

In some aspects of the present description, an optical assembly is provided, including an optical ferrule configured to receive light from an optical waveguide and including at least four ferrule alignment features; and a cradle securing the optical ferrule therein and configured to align the optical ferrule to an optical component, the cradle including at least four cradle alignment features configured to make contact or near contact with the at least four ferrule alignment features in a one to one correspondence in at least four corresponding contact regions, such that as a temperature of at least one of the cradle and the optical ferrule changes sufficiently, the corresponding alignment features of the optical ferrule and the cradle slide relative to each other causing the corresponding alignment features of the optical ferrule and the cradle to move to define corresponding traversed regions, such that when extended, the traversed regions of the at least four ferrule alignment features and the at least four cradle alignment features pass within 20 microns of a same first point.

In some aspects of the present description, an assembly is provided, including a first element having a first coefficient of thermal expansion C1; and a second element having a second coefficient of thermal expansion C2, C2≤0.5 C1, the first and second elements making at least four contacts or near contacts with each other in at least four corresponding contact regions, the contacts or near contacts keeping the first element substantially secured relative to the second element over at least a predetermined operational temperature range of the assembly, such that as a temperature of at least one of the first and second elements changes sufficiently, the at least four contact regions move to define at least four corresponding traversed regions, such that when extended, the traversed regions pass within 20 microns of a same first point.

In some aspects of the present description, an optical ferrule is provided, the optical ferrule configured to receive a central light ray from an optical fiber bonded to the optical ferrule along a first direction and redirect the received central light ray along a different second direction as a redirected central light ray, the optical ferrule configured to be substantially secured within a cradle by virtue of making a plurality of surface contacts or near contacts with the cradle, such that when extended, the plurality of surface contacts or near contacts and the redirected central light ray pass within 20 microns of a same first point.

In some aspects of the present description, an optical ferrule is provided, the optical ferrule configured to receive a central light ray from an optical fiber bonded to the optical ferrule along a first direction and redirect the received central light ray along a different second direction as a redirected central light ray, the optical ferrule configured to be substantially secured within a cradle by virtue of making a plurality of line contacts or near contacts with the cradle, such that as a temperature of optical ferrule changes sufficiently, the line contacts move to define corresponding traversed regions, such that when extended, the traversed regions and the redirected central light ray pass within 20 microns of a same first point.

In some aspects of the present description, an optical assembly is provided, the optical assembly including an optical ferrule configured to receive light from an optical waveguide and including at least four ferrule alignment features; and a cradle securing the optical ferrule therein and configured to align the optical ferrule to an optical component, the cradle including at least four cradle alignment features configured to make contact or near contact with the at least four ferrule alignment features in a one to one correspondence in at least four corresponding contact regions, such that when a size of at least one of the cradle and the optical ferrule changes sufficiently, the corresponding alignment features of the optical ferrule and the cradle slide relative to each other causing the corresponding alignment features of the optical ferrule and the cradle to move to define corresponding traversed regions, such that when extended, the traversed regions of the at least four ferrule alignment features and the at least four cradle alignment features pass within 20 microns of a same first point.

In some aspects of the present description, an optical ferrule is provided, the optical ferrule configured to be substantially secured within a cradle by virtue of making at least four surface contacts or near contacts with the cradle with at least four of the at least four surface contacts or near contacts not being coplanar, such that when extended, the at least four surface contacts or near contacts pass within 20 microns of a same first point.

In some aspects of the present description, an optical assembly is provided, the optical assembly including an optical ferrule configured to receive light from an optical waveguide and including at least four non-coplanar ferrule alignment surfaces that when extended, pass within 10 microns of a first point; and a cradle securing the optical ferrule therein and configured to align the optical ferrule to an optical component, the cradle including at least four non-coplanar cradle alignment surfaces that when extended, pass within 10 microns of a second point, such that within a predetermined operational temperature range of the optical assembly, the first and second points remain within 20 microns of each other.

In some aspects of the present invention, an assembly is provided, the assembly including a first element with at least four first alignment features, and a second element securing the first element therein, the second element including at least four second alignment features. The four second alignment features may be configured to make contact or near contact with the at least four first alignment features in a one to one correspondence in at least four corresponding contact regions. When a size of at least one of the first and second elements changes sufficiently, the corresponding alignment features of the first and second elements may slide relative to each other, causing the corresponding alignment features of the first and second elements to move to define corresponding traversed regions, such that when extended, the traversed regions of the at least four first alignment features and the at least four second alignment features pass within 20 microns of a same first point.

### BRIEF DESCRIPTION OF THE DRAWINGS

FIG. 1A is an exploded perspective view of an optical assembly, in accordance with an embodiment of the present description;

FIG. 1B is an assembled perspective view of an optical assembly, in accordance with an embodiment of the present description;

FIG. 1C is a perspective view of an optical assembly, in accordance with an alternate embodiment of the present description;

FIG. 1D is a cut-away view of an optical assembly, in accordance with an embodiment of the present description;

FIGS. 2A-2D are perspective views of an optical ferrule, in accordance with an embodiment of the present description;

FIGS. 3A-3C are perspective views of a cradle for an optical assembly, in accordance with an embodiment of the present description;

FIG. 4 is a close-up cut-away perspective view of alignment features for an optical assembly, in accordance with an embodiment of the present description;

FIG. 5 is a close-up perspective view of alignment features for an optical assembly, in accordance with an embodiment of the present description;

FIGS. 6A-6C illustrate the interaction of alignment features for an optical assembly, in accordance with an embodiment of the present description;

FIG. 7 details the placement of an alignment feature for an optical ferrule, in accordance with an embodiment of the present description;

FIG. 8 details the placement of alignment features for an optical ferrule, in accordance with an embodiment of the present description;

FIG. 9 details the interactions of alignment features for components of an optical assembly, in accordance with an embodiment of the present description;

FIG. 10 illustrates the relative positioning of alignment features for components of an optical assembly, in accordance with an embodiment of the present description;

FIG. 11 is a cutaway view of an optical assembly, in accordance with an embodiment of the present description; and

FIGS. 12A-12C illustrates the relative positioning of alignment features for an optical ferrule and cradle for an optical assembly, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

According to some aspects of the present description, an optical assembly (e.g., a connector for an optical component) includes an optical ferrule and a corresponding cradle configured to align the optical ferrule to an optical component (e.g., a photonic integrated circuit, or PIC). In some embodiments, the optical ferrule may be configured to receive light from an optical waveguide (e.g., an optical fiber, or cable of optical fibers) and may include at least three ferrule alignment features (i.e., features designed to help align the ferrule with the cradle and optical component). In some embodiments, the cradle may include at least three cradle alignment features configured to make contact or near contact with the at least three ferrule alignment features in a one to one correspondence in at least three corresponding contact regions. In some embodiments, the at least three ferrule alignment features may be four or more ferrule alignment features, and the at least three cradle alignment features may be four or more cradle alignment features. In some embodiments, the alignment features of the optical ferrule and the cradle may be configured such that, as a temperature of the cradle and/or the optical ferrule changes sufficiently, the corresponding alignment features of the optical ferrule and the cradle slide relative to each other, causing the corresponding alignment features of the optical ferrule and the cradle to move to define corresponding traversed regions (i.e., a path or plane defined by the travel of an alignment feature through space), such that when extended, the traversed regions of the at least three ferrule alignment features and the at least three cradle alignment features pass within 20 microns of a same first point. In some embodiments, the first point may be a center of expansion substantially shared by the optical ferrule and the cradle. In some embodiments, the optical assembly may have a predetermined operational temperature range over which contacts or near contacts between the at least three ferrule and cradle alignment surfaces will substantially prevent relative lateral movement between the optical ferrule and the cradle (i.e., keeping the components substantially aligned).

In some embodiments, each of the at least three ferrule alignment features is a surface. In some embodiments, each of the at least three cradle alignment features is a surface. In some embodiments, at least one ferrule alignment feature in the at least three ferrule alignment features is substantially a line. In some embodiments, at least one cradle alignment feature in the at least three cradle alignment features is substantially a line. In some embodiments, at least one ferrule alignment feature in the at least three ferrule alignment features is substantially a point. In some embodiments, at least one cradle alignment feature in the at least three cradle alignment features is substantially a point.

For the purposes of this specification, an optical ferrule is a component of an optical assembly which accepts a light guide (e.g., the stripped end of an optical fiber) and aligns it with another optical component (e.g., a PIC). In some embodiments, the optical ferrule may include a light redirecting member configured to receive light from the optical waveguide along a first direction (i.e., a direction substantially parallel to the optical waveguide), and redirect the received light along a different second direction. In some embodiments, the light redirecting member may rely on total internal reflection to redirect the light entering or exiting the optical waveguides attached to the light redirecting member. For the purposes of this specification, a cradle is a component configured to accept a mating optical ferrule and align that optical ferrule with another optical component (e.g., a PIC). In some embodiments, the cradle may be configured to be attached (e.g., soldered, glued, or otherwise attached) to a PIC or printed circuit board. In some embodiments, the optical ferrule may have a relatively high coefficient of thermal expansion and the cradle may have a relatively low coefficient of thermal expansion. For example, in some embodiments, the coefficients of thermal expansion of the optical ferrule and the cradle may differ by at least a factor of 2, or at least a factor of 5.

In some embodiments, the optical assembly may be configured such that, despite a measurable difference in thermal expansion properties, the optical components will stay substantially aligned when the temperature of at least one of the optical components in the assembly changes significantly. That is, in some embodiments, the respective alignment features of the optical ferrule and the cradle may be aligned such that both the optical ferrule and cradle share a fixed center of expansion.

In some embodiments, and at least at room temperature, each pair of corresponding optical ferrule and cradle alignment features may make near contact with each other, the near contact defining a clearance gap at the contact region between the ferrule and cradle alignment features. In some embodiments, and at least at room temperature, at least one pair of corresponding ferrule and cradle alignment features make near contact with each other, and at least one other pair of corresponding ferrule and cradle alignment features make contact with each other. In some embodiments, at least one of the ferrule alignment features may be substantially perpendicular to a thickness direction of the ferrule. In some embodiments, at least two, or at least three, of the ferrule alignment features may be substantially perpendicular to each other. In some embodiments, at least one of the cradle alignment features may be substantially perpendicular to a thickness direction of the cradle. In some embodiments, at least two, or at least three, of the cradle alignment features may be substantially perpendicular to each other.

The path or plane defined by the travel of an alignment feature through space (i.e., as the optical ferrule and/or the cradle expand and contract in response to changes in temperature) define “traversed regions.” In some embodiments, at least one of these traversed regions is substantially a line, such that when extended, the line passes within 20 microns of the first point (e.g., a shared center of expansion). In some embodiments, the traversed regions defined by the ferrule alignment features and the cradle alignment features may pass within 10 microns, or within 5 microns, or within 1 micron of the first point. In some embodiments, all the traversed regions are substantially planes, such that when extended, each plane passes within 20 microns of the first point (i.e., the point of intersection between any two of the extended planes will be at a point within 10 microns of the first point).

According to some aspects of the present description, an assembly includes a first element having a first coefficient of thermal expansion, C1, and a second element having a second coefficient of thermal expansion, C2, such that C2 is less than or equal to about 0.5 C1, or less than or equal to about 0.1C1, or less than or equal to about 0.01C1. In some embodiments, the first element may be an optical ferrule and the second element may be a cradle. In some embodiments, the first and second elements may make at least three contacts or near contacts with each other in at least three corresponding contact regions. In some embodiments, the contacts or near contacts may keep the first element substantially secured relative to the second element over at least a predetermined operational temperature range of the assembly. That is, as a temperature of the first and/or second elements changes sufficiently, the contact regions may move to define corresponding traversed regions, such that when extended, the traversed regions pass within 20 microns of a same first point (e.g., a common center of expansion for both the first and second elements.)

According to some aspects of the present description, an optical ferrule may be configured to receive a central light ray from an optical fiber (or other optical waveguide) bonded to the optical ferrule along a first direction and redirect the received central light ray along a different second direction to create a redirected light ray. In some embodiments, the optical ferrule may be configured to be substantially secured within a corresponding cradle by virtue of making a number of surface contacts or near contacts with the cradle. In some embodiments, when these surface contacts or near contacts are extended, the surface contacts or near contacts and the redirected light ray may pass within 20 microns of a same first point (e.g., a center of expansion substantially shared between the optical ferrule and the cradle).

According to some aspects of the present description, an optical ferrule may be configured to receive a central light ray from an optical fiber (or other optical light guide) bonded to the optical ferrule along a first direction (e.g., substantially in line with the optical fiber) and redirect the received central light ray along a different second direction as a redirected central light ray. In some embodiments, the optical ferrule may be configured to be substantially secured within a cradle by a number of line contacts or near contacts with the cradle, such that as a temperature of optical ferrule changes sufficiently, the line contacts move to define corresponding traversed regions. In some embodiments, when these traversed regions are extended, the extended traversed region and the redirected central light ray pass within 20 microns of a same first point (e.g., a center of expansion substantially shared between the optical ferrule and the cradle).

The type of contacts made between the alignment features of the optical ferrule and the cradle are defined by the shape of the corresponding alignment features. For example, contact between two substantially planar alignment features may be a plane (i.e., a surface). Contact between a cylindrical alignment feature and a planar alignment feature may be a line contact (i.e., the line defined where the surface of the cylinder rests against the planar surface.) Contact between a spherical alignment feature and a planar alignment feature may be a point (i.e., the point where the sphere makes contact with the planar alignment feature.)

According to some aspects of the present description, an optical assembly may include an optical ferrule configured to receive light from an optical waveguide (e.g., an optical fiber), and a cradle securing the optical ferrule and configured to align the optical ferrule to an optical component (e.g., a PIC). In some embodiments, the optical ferrule may include at least three ferrule alignment features, and the cradle may include at least three corresponding cradle alignment features. In some embodiments, the cradle alignment features may be configured to make contact or near contact with the ferrule alignment features in a one-to-one correspondence in at least three corresponding contact regions. In some embodiments, when a size of the cradle and/or the optical ferrule changes sufficiently, the corresponding alignment features of the optical ferrule and the cradle slide relative to each other, causing the corresponding alignment features of the optical ferrule and the cradle to move to define corresponding traversed regions (i.e., a path or plane defined by the travel of an alignment feature through space). In some embodiments, when the traversed regions are extended, the traversed regions of the ferrule alignment features and the cradle alignment features may pass within 20 microns of a same first point (e.g., a shared center of expansion).

According to some aspects of the present description, an optical ferrule may be configured to be substantially secured within a cradle by virtue of making at least three surface contacts or near contacts with the cradle. In some embodiments, at least three of the surface contacts or near contacts may not be coplanar, such that, when extended, the surface contacts or near contacts pass within 20 microns of a same first point (e.g., a shared center of expansion). In some embodiments, the at least three surface contacts or near contacts may include at least four, or at least six, surface contacts or near contacts, with at least three of the surface contacts or near contacts not being coplanar.

According to some aspects of the present description, an optical assembly may include an optical ferrule configured to receive light from an optical waveguide (e.g., an optical fiber) and may include at least three non-coplanar ferrule alignment surfaces that, when the surfaces are extended, pass within 10 microns of a first point (e.g., a center of expansion for the optical ferrule). In some embodiments, the optical assembly may also include a cradle configured to secure the optical ferrule therein and to align the optical ferrule to an optical component. In some embodiments, the cradle may include at least three non-coplanar cradle alignment surfaces that, when the surfaces are extended, pass within 10 microns of a second point (e.g., a center of expansion for the cradle), such that, within a predetermined operational temperature range of the optical assembly, the first and second points remain within 20 microns of each other.

According to some aspects of the present invention, an assembly may include a first element with at least three first alignment features, and a second element securing the first element therein, the second element including at least three second alignment features. In some embodiments, the first element may be a first optical component in an optical assembly (e.g., an optical ferrule), and the second element may be a second optical component in an optical assembly (e.g., a cradle configured to mate with an optical ferrule). However, the first and second elements may be any appropriate elements in any appropriate system designed to connect in a mating arrangement. The three second alignment features may be configured to make contact or near contact with the at least three first alignment features in a one to one correspondence in at least three corresponding contact regions. When a size of at least one of the first and second elements changes sufficiently (e.g., due to material aging, physical stresses, temperature changes, solvent swelling, etc.), the corresponding alignment features of the first and second elements may slide relative to each other, causing the corresponding alignment features of the first and second elements to move to define corresponding traversed regions, such that when extended, the traversed regions of the at least three first alignment features and the at least three second alignment features pass within 20 microns of a same first point. In some embodiments, the sizes of the first and second elements may change at substantially the same rate and time. In other embodiments, the sizes of the first and second elements may change differentially (i.e., may change at different rates and/or times, or the size of only one element may change while the other remains substantially static.)

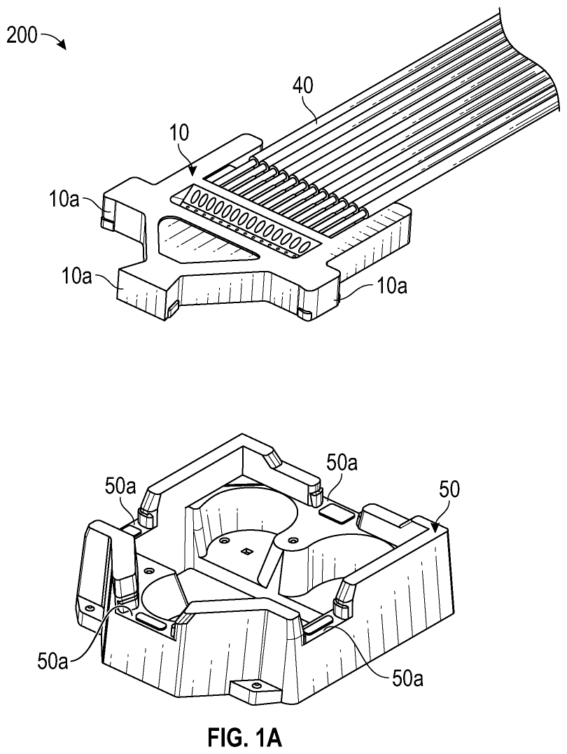

Turning now to the figures, FIGS. 1A-1D provide alternate views of an embodiment of an optical assembly of the present description. FIG. 1A is an exploded perspective view of an embodiment of an optical assembly 200. It should be noted that, although the examples provided herein relate primarily to optical assemblies, the same concepts may be applied to the mating components of other systems. For example, the systems and methods described herein may be used to maintain alignment between components of dissimilar materials in a coordinate measuring machine (CMM) system, thus reducing the need for more expensive alloys with a near-zero coefficient of thermal expansion (e.g., Invar). In another example, the systems and methods described herein may be used to maintain alignment between a component cavity and a mold-in-place epoxy insert that shrinks during a curing process. These examples are not intended to be limiting in any way.

In some embodiments, optical assembly 200 includes an optical ferrule 10 and a cradle 50. Optical ferrule 10 accepts an optical waveguide 40, such as an optical fiber or optical cable, and redirects light received from optical waveguide 40 into an optical component (not shown) such as a PIC. Optical ferrule 10 is configured to be accepted and held by cradle 50. In some embodiments, engagement features 10a of optical ferrule 10 may be accepted into corresponding engagement features 50a on cradle 50. When properly seated within cradle 50, optical ferrule 10 is held substantially in alignment with cradle 50, as well as an optical component adjacent to cradle 50 (e.g., a PIC on a printed circuit board over which the cradle 50 may be mounted).

FIG. 1B is an assembled perspective view of optical assembly 200 of FIG. 1A, showing optical ferrule 10 seated in cradle 50, such that the engagement features 10a of optical ferrule 10 are disposed within or adjacent to corresponding engagement features 50a of cradle 50. In some embodiments, optical ferrule 10 may be further held in place by an attractive force, such as a magnetic attraction between optical ferrule 10 and cradle 50, although any appropriate means may be used to hold optical ferrule 10 and cradle 50 together, including, but not limited to, mechanical features (e.g., snap fit features), adhesives, springs, and/or additional components (e.g., a third piece, such as a cover). FIG. 1C provides a perspective view of optical assembly 200 demonstrating a cap piece 55 in place, such that optical ferrule 10 is sandwiched between cradle 50 and cap piece 55. In some embodiments, the cap piece 55 may be attracted or attached to cradle 50, rather than optical ferrule (e.g., a magnetic attraction may exist between cap piece 55 and cradle 50).

FIG. 1D is a cut-away view of optical assembly 200, showing additional interior detail on the assembly. Light 30 is received by optical ferrule 10 from optical waveguide 40 in a first direction 31 substantially parallel with optical waveguide 40. Light 30 becomes incident on light redirecting feature 33, which redirects light 30 to a second direction 32. Optical ferrule 10 is held in alignment with an optical component 60 by cradle 50, such that redirected light 30 falls incident on optical component 60. In some embodiments, optical component 60 may be, but is not limited to, a PIC, a lens, a sensor, VCSEL (vertical cavity surface emitting laser), or any other appropriate optical component capable of receiving or transmitting light 30. In some embodiments, optical component 60 and cradle 50 may be mounted on a substrate 45 such as a printed circuit board (PCB). In some embodiments, an additional component 55 (e.g., a cap piece) may be used to hold optical ferrule 10 in place in cradle 50. In some embodiments, magnetic components 57 may be disposed in or on cradle 50 to provide an attractive force to optical ferrule 10, cap piece 55, or both.

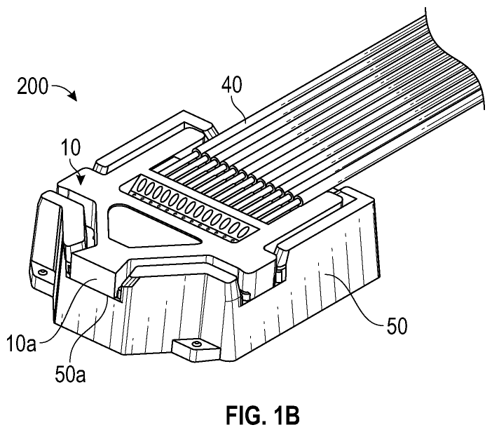

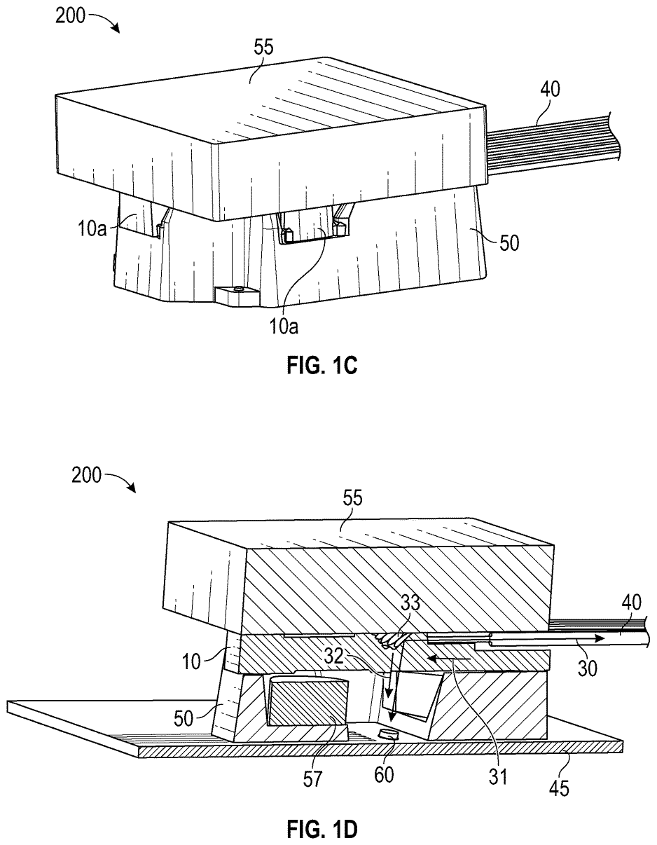

Ferrule engagement features 10a and cradle engagement features 50a may each include alignment features to provide additional positioning assistance. FIGS. 2A-2D are perspective views showing alignment features on an optical ferrule, and FIGS. 3A-3C are perspective views showing corresponding alignment features on a cradle. Looking simultaneously at FIGS. 2A-2D, and in some embodiments, optical ferrule 10 has a first set of ferrule alignment features 11 on the vertical side surfaces of engagement features 10a, and a second set of ferrule alignment features 12 on the bottom surfaces of engagement features 10a. For the purposes of this discussion, the “bottom” surface of ferrule 10 shall be defined as a major side adjacent to and facing a corresponding mating surface of the cradle when optical ferrule 10 is engaged with the cradle (e.g., the optical assembly as shown in FIG. 1B). In some embodiments, each of ferrule alignment features 11, 12 are configured to make contact or near contact with corresponding alignment features on the cradle (discussed in FIGS. 3A-3C). In some embodiments, the ferrule alignment features 11, 12 may be surfaces (e.g., a raised shape such as a polygon), lines or ridges, or points with minimal contact area. However, the ferrule alignment features 11, 12 may be any appropriate size or shape.

Looking simultaneously at FIGS. 3A-3C, and in some embodiments, cradle 50 has a first set of cradle alignment features 51 on the vertical side surfaces of engagement features 50a, and a second set of cradle alignment features 52 on the top surfaces of engagement features 50a. For the purposes of this discussion, the “top” surface of cradle engagement features 50a shall be defined as a surface adjacent to and facing a corresponding mating surface of the optical ferrule when optical ferrule is engaged with the cradle 50. That is, in some embodiments, ferrule alignment features 12 may be resting on (in direct contact with) cradle alignment features 52. In some embodiments, each of cradle alignment features 51, 52 are configured to make contact or near contact with corresponding alignment features on the optical ferrule (discussed in FIGS. 2A-2D). In some embodiments, the cradle alignment features 51, 52 may be surfaces (e.g., a raised shape such as a polygon), lines or ridges, or points with minimal contact area. However, the cradle alignment features may be any appropriate size or shape. In some embodiments, the number of ferrule alignment features may be equal to the number of cradle alignment features. In some embodiments, the number of ferrule alignment features may differ from the number of cradle alignment features.

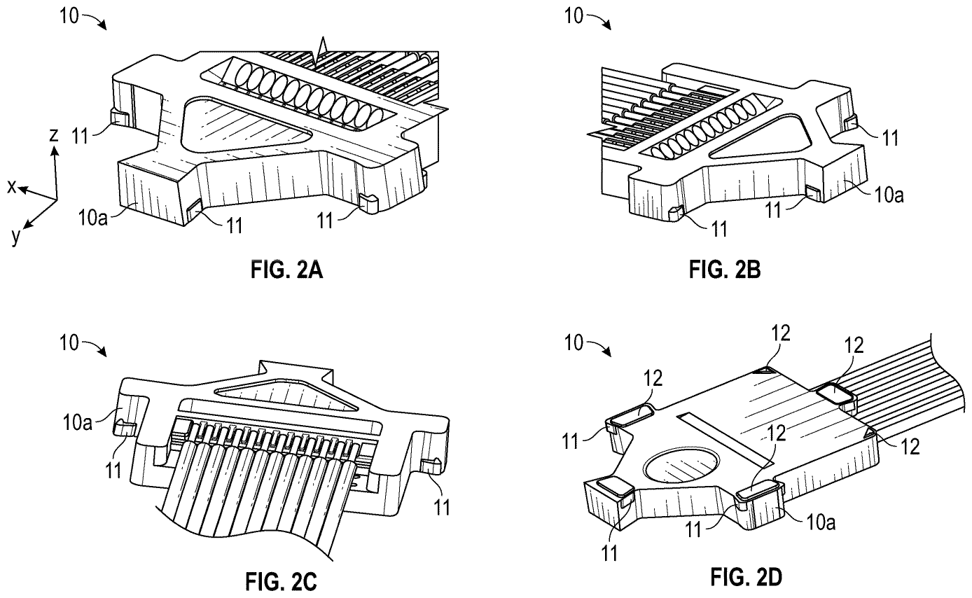

FIG. 4 is a close-up, cutaway view of an optical assembly detailing the interaction of alignment features of the present description. In the embodiment of FIG. 4, an optical ferrule 10 is seated in cradle 50, showing how the two components may have one or more contact regions 70 where ferrule alignment features 11a are in direct contact with cradle alignment features 51a (i.e., there is at least one point in contact region 70 where there is no distance between ferrule alignment feature 11a and corresponding cradle alignment feature 51a. As the optical ferrule 10 and/or cradle 50 are subject to expansion or contraction, potentially at significantly different rates and over a variety of temperatures, ferrule alignment features 11a may move relative to cradle alignment features 51a, such that a relatively small clearance gap (i.e., an area of near contact) exists between the features.

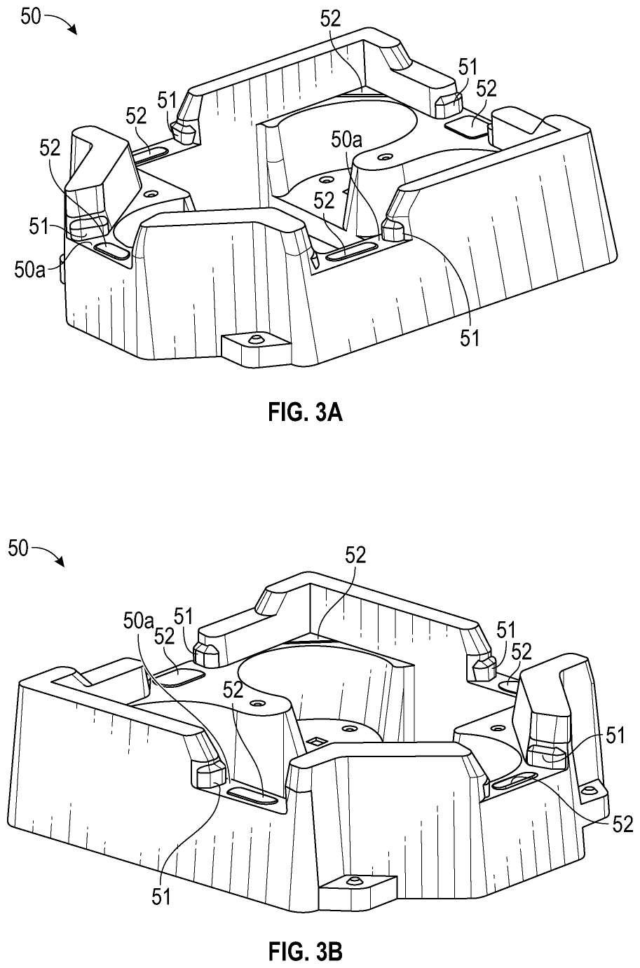

FIG. 5 details is a close-up perspective view of alignment features for an optical assembly, showing clearance gaps between the alignment features. In the embodiments of FIG. 5, optical ferrule 10 and cradle 50 are disposed such that a clearance gap 71 exists in contact region 70 between ferrule alignment feature 11b and cradle alignment feature 51b. In some embodiments, clearance gap 71 may widen, narrow, or close entirely as the optical ferrule 10 and/or the cradle 50 change in size in response to local or global variations in temperature. In some embodiments, the optical ferrule 10 and/or cradle 50 may be configured to provide a clearance gap 71 at a room temperature (e.g., to allow for manufacturing tolerances).

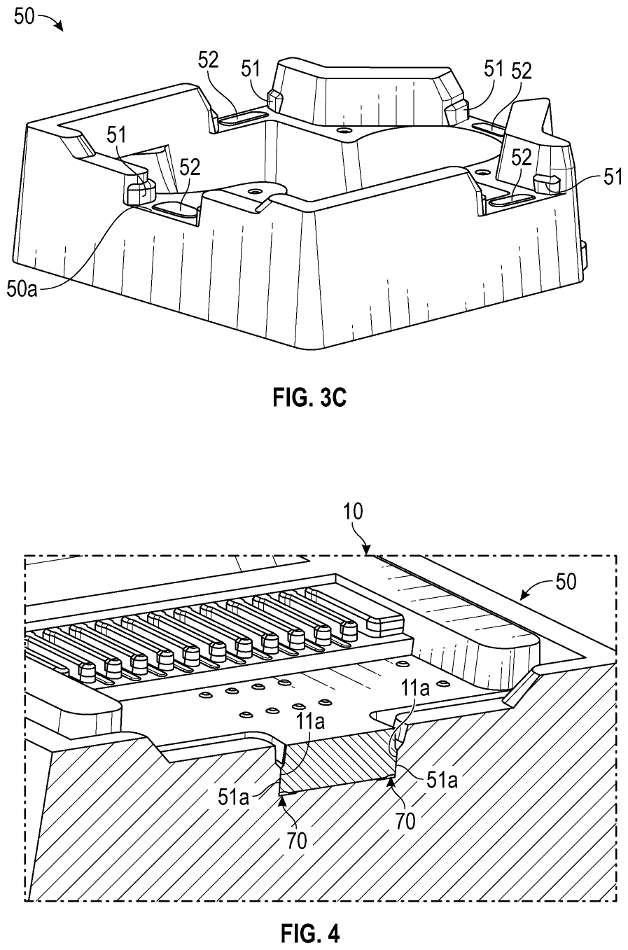

FIGS. 6A-6C illustrate the interaction of alignment features for an embodiment of an optical assembly of the present description. FIGS. 6A-6C should be examined together for the following discussion. In FIG. 6A, an optical ferrule 10 is seated in cradle 50, such that ferrule engagement feature 10a is disposed in cradle engagement feature 50a. In the embodiment of FIG. 6A, ferrule alignment features 11 are in direct contact with cradle alignment features 51 in contact regions 70. FIG. 6B provides an alternate view of the assembly, showing contact regions 70 as seen from above. FIG. 6C is a cutaway view of the assembly, provided to show contact region 80 between a bottom surface of ferrule engagement features 10a and a mating surface of cradle engagement features 50a (between ferrule alignment features 12, see FIG. 2D, and cradle alignment features 52, see FIG. 3A). FIG. 6C shows direct contact between the optical ferrule 10 and cradle 50 in contact region 80.

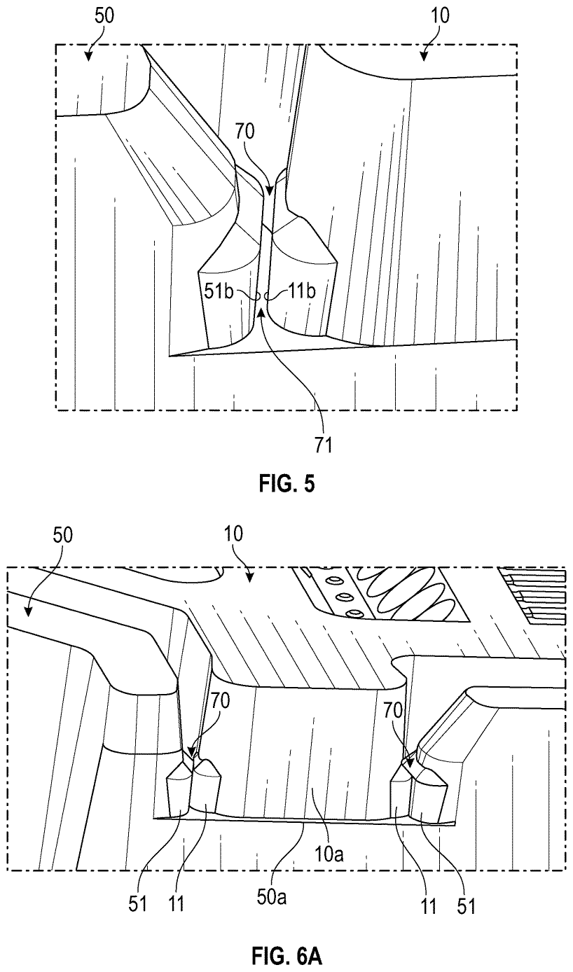

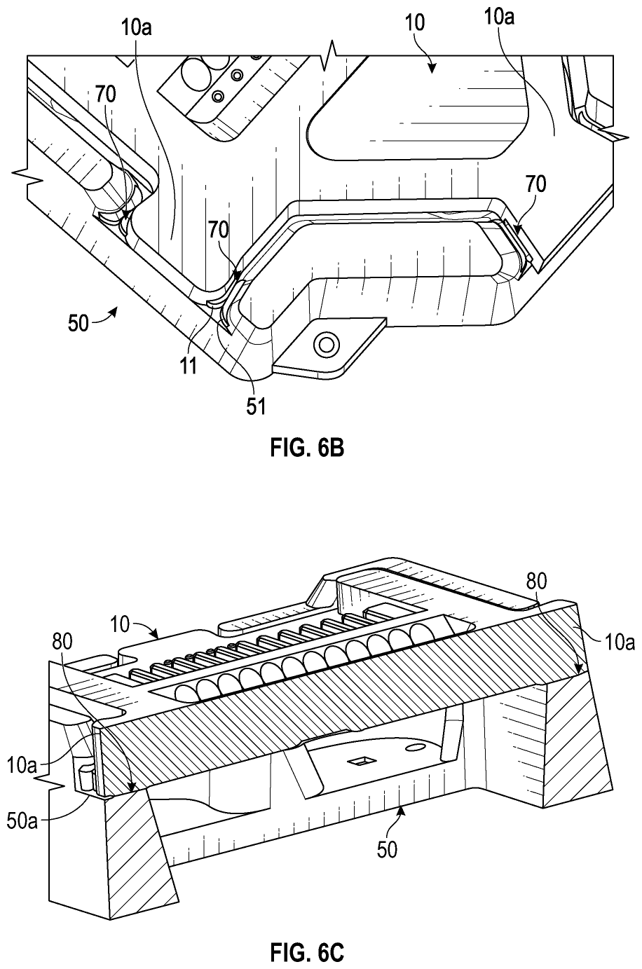

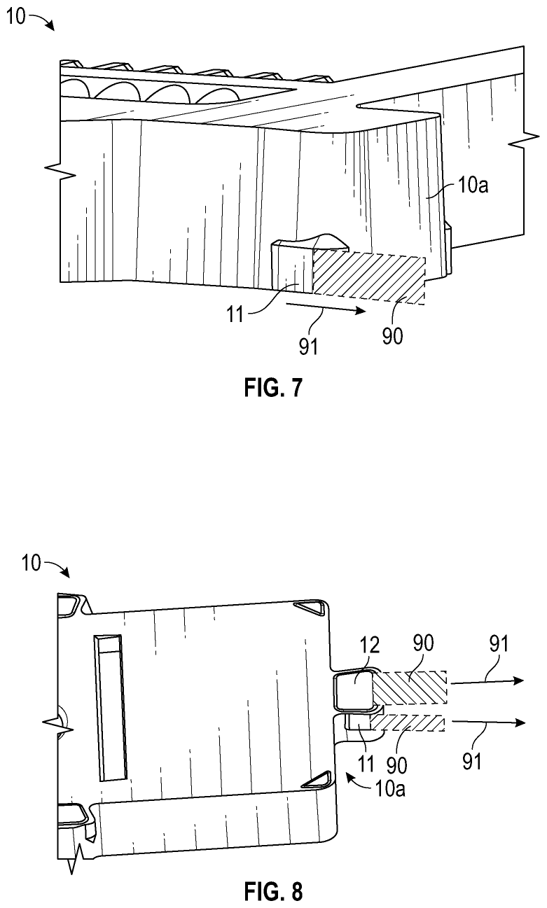

FIGS. 7-9 illustrate how the alignment features of both the ferrule and the cradle may move (e.g., expansion of the optical ferrule may cause one or more alignment features to “slide” in space) to define traversed regions (i.e., a path or plane defined by the travel of an alignment feature through space). By careful design of the optical ferrule and the cradle, as well as their respective alignment features, it is possible to have each of the traversed regions, if extended, cross at or near a shared center of expansion for the optical assembly, ensuring maintained alignment of the optical ferrule and any adjacent optical components. FIG. 7 shows a close-up view of a ferrule engagement feature 10a with ferrule alignment feature 11. If ferrule alignment feature 11 moves in space in direction 91 (perhaps due to expansion of optical ferrule 10), the ferrule alignment feature 11 defines a path, creating traversed region 90. FIG. 8 illustrates a similar concept, showing ferrule alignment features 11 and 12 moving in direction 91 to define traversed regions 90. FIG. 9 shows traversed regions 90 and 100, corresponding to the travel of ferrule alignment feature 11 (in direction 91) and cradle alignment feature 51 (in direction 101), respectively. In some embodiments, such as the embodiment of FIG. 9, the traversed regions 90 and 100 may be substantially aligned (i.e., the direction of expansion and/or contraction is substantially similar).

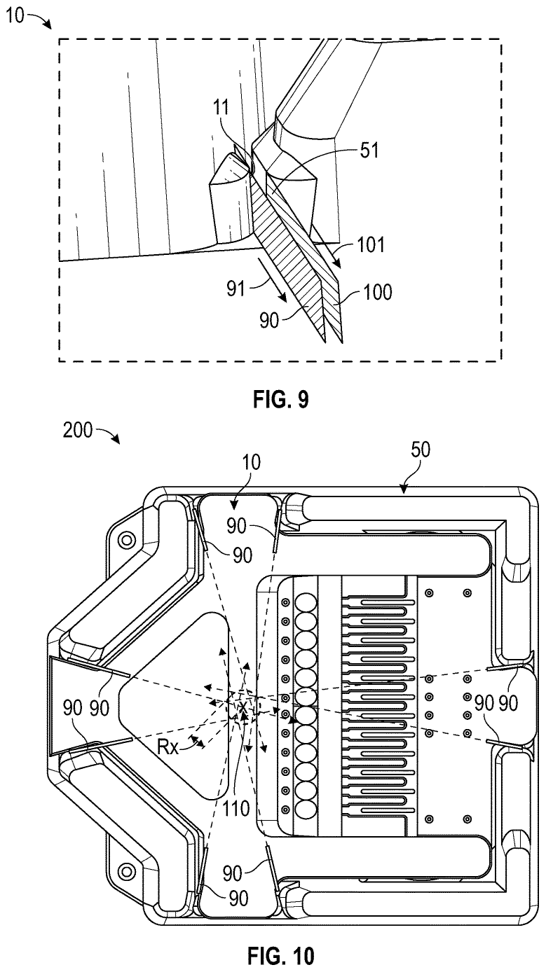

FIG. 10 is a top view of optical assembly 200, showing the relative positioning of alignment features for an embodiment of the present description. For simplicity, only traversed regions 90, corresponding to the ferrule alignment features (such as 11, FIGS. 2A-2D), are shown. Dashed arrows show now traversed regions 90 can each be extended deeper into the assembly 200 such that they approach a common point 110. In some embodiments, common point 110 may be a center of thermal expansion for the optical ferrule 10, or a center of expansion shared between the optical ferrule 10 and cradle 50. In fact, in some embodiments, extending traversed regions 100 (not shown in FIG. 10, but illustrated in FIG. 9) in a similar manner will show the extended traversed regions 100 converging on common point 110. In some embodiments, the extended traversed regions 90, 100 may pass within 20 microns, or within 10 microns, or within 5 microns of common point 110. That is, the extended traversed regions 90, 100 may each pass within a radius Rx of common point 110.

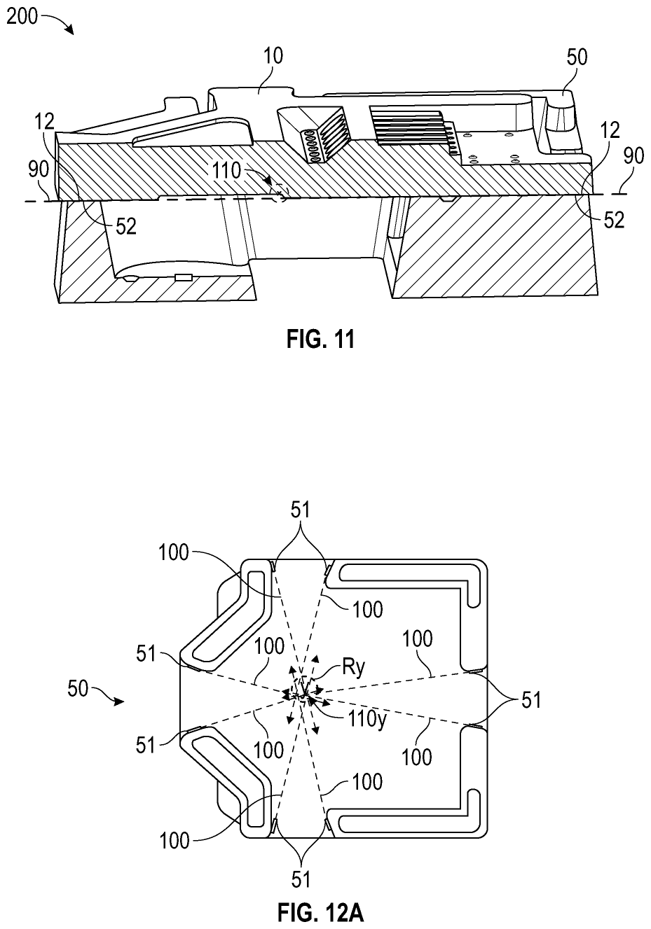

FIG. 11 is a cutaway view of the optical assembly 200 of FIG. 10, showing how, in some embodiments, the traversed regions 90 defined by the travel of ferrule alignment features 12 (i.e., the alignment features on the bottom surface of the optical ferrule 10) may also converge on a common point 110. In some embodiments, the traversed regions defined by cradle alignment features 52 (not shown) may also converge on common point 110.

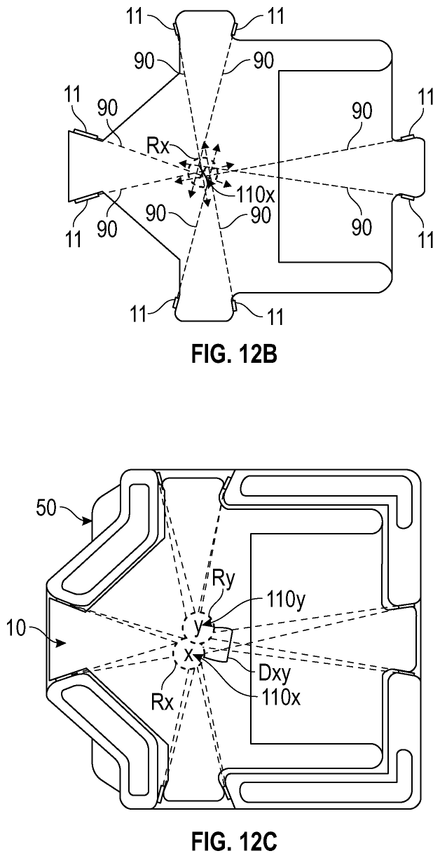

The previous figures have shown a single common point of convergence which, in some embodiments, may be shared by both the optical ferrule and cradle. In some embodiments, however, the optical ferrule and cradle may have different, albeit similar, common points of convergence (i.e., common centers of expansion). FIGS. 12A-12C illustrate the alignment of centers of expansion for an optical ferrule and cradle in an optical assembly of the present description. FIG. 12A provides a top view of an embodiment of cradle 50 with cradle alignment features 51. In some embodiments, the cradle 50 may be configured such that, when the non-coplanar alignment surfaces of alignment features 51 are extended in space, they will converge on substantially the same first point (e.g., pass within 10 microns of the same point). Stated another way, the movement (due to expansion and/or contraction) of cradle alignment features 51 define traversed regions 100. When extended (as shown by dashed arrows), traversed regions 100 can be seen to converge on a common point 110y (e.g., the cradle's center of expansion), such that all of the extended traversed regions 100 pass within radius Ry of common point 110y. In some embodiments, Ry may be less than or equal to about 10 microns.

Similarly, FIG. 12B provides a top view of an embodiment of optical ferrule 10 with ferrule alignment features 11. In some embodiments, the optical ferrule 10 may be configured such that, when the non-coplanar alignment surfaces of alignment features 11 are extended in space, they will converge on substantially the same second point (e.g., pass within 10 microns of the same point). Stated another way, the movement (due to expansion and/or contraction) of ferrule alignment features 11 define traversed regions 90. When extended (as shown by dashed arrows), traversed regions 90 can be seen to converge on a common point 110x (e.g., the optical ferrule's center of expansion), such that all of the extended traversed regions 90 pass within radius Rx of common point 110x. In some embodiments, Rx may be less than or equal to about 10 microns.

FIG. 12C provides a top view of both the optical ferrule 10 and cradle 50 in assembled form. When thus assembled, it can be seen that, in some embodiments, the common point 110x of the optical ferrule 10 may not line up exactly with common point 110y of cradle 50. In some embodiments, however, a distance Dxy between point 110x and point 110y may be less than or equal to about 20 microns.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. An optical assembly, comprising:
an optical ferrule configured to receive light from an optical waveguide and comprising at least four ferrule alignment features; and
a cradle securing the optical ferrule therein and configured to align the optical ferrule to an optical component, the cradle comprising at least four cradle alignment features configured to make contact or near contact with the at least four ferrule alignment features in a one to one correspondence in at least four corresponding contact regions, such that as a temperature of at least one of the cradle and the optical ferrule changes sufficiently, the corresponding alignment features of the optical ferrule and the cradle slide relative to each other causing the corresponding alignment features of the optical ferrule and the cradle to move to define corresponding traversed regions, such that when extended, at least one location along the extended traversed regions of the at least four ferrule alignment features and the at least four cradle alignment features are disposed within 20 microns of a same first point.

2. The optical assembly of claim 1, wherein the optical ferrule is configured to receive light from an optical waveguide along a first direction and redirect the received light along a different second direction.

3. The optical assembly of claim 1, wherein at at least a room temperature, each pair of corresponding ferrule and cradle alignment features make near contact with each other, the near contact defining a clearance gap at the contact region between the ferrule and cradle alignment features.

4. The optical assembly of claim 1, wherein at at least one temperature, at least one pair of corresponding ferrule and cradle alignment features make near contact with each other, and at least one other pair of corresponding ferrule and cradle alignment features make contact with each other.

5. The optical assembly of claim 1, wherein at least one traversed region is a line, such that when extended, at least one location on the line is disposed within 10 microns of the first point.

6. The optical assembly of claim 1, wherein the traversed regions of the at least four ferrule alignment features and the at least four cradle alignment features are disposed such that at least one location along each traversed region is disposed within 10 microns of the first point.

7. The optical assembly of claim 1, wherein the traversed regions of the at least four ferrule alignment features and the at least four cradle alignment features are disposed such that at least one location along each traversed region is disposed within 5 microns of the first point.

8. The optical assembly of claim 1, wherein the traversed regions of the at least four ferrule alignment features and the at least four cradle alignment features are disposed such that at least one location along each traversed region is disposed within 1 micron of the first point.

9. The optical assembly of claim 1, wherein all the traversed regions are planes, such that when extended, at least one location on each plane is disposed within 10 microns of the first point.

10. The optical assembly of claim 1, such that within a predetermined operational temperature range of the optical assembly, contacts or near contacts between the at least four ferrule and cradle alignment surfaces prevent relative lateral movement between the optical ferrule and the cradle.

11. The optical assembly of claim 1, wherein at least one ferrule alignment feature in the at least four ferrule alignment features is perpendicular to a thickness direction of the ferrule.

12. The optical assembly of claim 1, wherein at least two ferrule alignment features in the at least four ferrule alignment features are perpendicular to each other.

13. The optical assembly of claim 1, wherein at least one cradle alignment feature in the at least four ferrule alignment features is perpendicular to a thickness direction of the cradle.

14. The optical assembly of claim 1, wherein at least two cradle alignment features in the at least four cradle alignment features are perpendicular to each other.

15. The optical assembly of claim 1, wherein the coefficients of thermal expansion of the optical ferrule and the cradle are different by at least a factor of 2.

16. The optical assembly of claim 1, wherein the coefficients of thermal expansion of the optical ferrule and the cradle are different by at least a factor of 5.

17. An assembly comprising:
a first element having a first coefficient of thermal expansion C1; and
a second element having a second coefficient of thermal expansion C2, C2≤0.5 C1, the first and second elements making at least four contacts or near contacts with each other in at least four corresponding contact regions, the contacts or near contacts keeping the first element secured relative to the second element over at least a predetermined operational temperature range of the assembly, such that as a temperature of at least one of the first and second elements changes sufficiently, the at least four contact regions move to define at least four corresponding traversed regions, such that when extended, at least one location along the extended traversed regions of the at least four ferrule alignment features and the at least four cradle alignment features are disposed within 20 microns of a same first point.

18. The assembly of claim 17, wherein C2≤0.1C1 .

19. The assembly of claim 17, wherein C2≤0.01C1 .

20. An optical ferrule configured to receive a central light ray from an optical fiber bonded to the optical ferrule along a first direction and redirect the received central light ray along a different second direction as a redirected central light ray, the optical ferrule configured to be secured within a cradle by virtue of making a plurality of surface contacts or near contacts with the cradle, such that when extended, at least one location along each extended surface contact or extended near contact of the plurality of surface contacts or near contacts and the redirected central light ray are disposed within 20 microns of a same first point.
